(19) United States
(12) Patent Application Publication
(10) Pub. No.: US 2026/0315905 A1
(43) Pub. Date: Oct. 15, 2026

(54) NAVIGATION WITHIN A GAMING ENVIRONMENT ASSOCIATED WITH AN EXERCISE MACHINE

(71) Applicant: Peloton Interactive, Inc., New York, NY (US)

(72) Inventors: Rob KAY, San Francisco, CA (US); Jim GREEN, Brooklyn, NY (US); Thomas WESTERLIN, San Francisco, CA (US); Paul BLIEKA, Flushing, NY (US)

(21) Appl. No.: 19/457,938

(22) Filed: Jan. 23, 2026

Related U.S. Application Data
(60) Provisional application No. 63/749,248, filed on Jan. 24, 2025.

(51) Int. Cl. A63B 71/06; A63B 24/00

(52) U.S. Cl. CPC A63B 71/0619; A63B 24/0062; A63B 2071/0647

(57) ABSTRACT

Systems and methods that enhance an exercise activity performed by a user are described. In some embodiments, the systems and methods include a gaming platform that presents video games, virtual games, and other digital or interactive experiences to players that are working out or performing an exercise activity using an exercise machine. For example, an exercise machine or device, such as a treadmill, exercise bicycle, rower, strength machine, and so on, enables users to perform exercise activities while experiencing a virtual gaming environment. The virtual gaming environment may present user-selectable navigation options to users via diegetic objects (e.g., objects rendered within the virtual environment), maintain certain viewing angles of the virtual environment as the user performs the exercise activity, cause an avatar associated with the user to mimic the user's movements or gestures, and so on.

### CROSS-REFERENCE TO RELATED APPLICATIONS

This application claims priority to U.S. Provisional Patent Application No. 63/749,248, filed on Jan. 24, 2025, entitled NAVIGATION WITHIN A GAMING ENVIRONMENT ASSOCIATED WITH AN EXERCISE MACHINE, which is hereby incorporated by reference in its entirety.

### BACKGROUND

The world of connected fitness is an ever-expanding one. This world can include a user taking part in an activity (e.g., running, cycling, lifting weights, and so on), other users also performing the activity, and many other users doing other activities. The users may be exercising on a fitness machine (e.g., a treadmill, a stationary bike, a strength machine, a stationary rower, and so on), or may be moving through the world on a bicycle, boat, skiing, or other exercise equipment.

The users can also be performing activities that do not include an associated machine or other equipment, such as running, strength training, yoga, stretching, hiking, climbing, and so on. These users can have a wearable device or mobile device that monitors the activity and may perform the activity in front of a user interface (e.g., a display or device) presenting content associated with the activity.

The user interface, whether a mobile device, a display device, or a display that is part of a machine, can provide or present interactive content to the users. For example, the user interface can present live or recorded classes, video tutorials of activities, leaderboards and other competitive or interactive features, progress indicators (e.g., via time, distance, and other metrics), virtual games or interactive experiences, augmented or mixed reality scenarios, and so on.

For example, the interactive content can include video or images that mimic or simulate the user traveling or moving (e.g., running, biking, rowing, and so on) through a virtual environment, such as a via an avatar representing the user that moves within a virtual game or other digitally rendered interactive environment.

### BRIEF DESCRIPTION OF THE DRAWINGS

Embodiments of the present technology will be described and explained through the use of the accompanying drawings.

FIG. 1 is a block diagram illustrating a suitable network environment for users of a gaming platform.

FIG. 2 is a block diagram illustrating components of a gaming platform.

FIG. 3 is a flow diagram illustrating a method for performing a game action within a virtual environment.

FIG. 4 is a flow diagram illustrating a method for adjusting a view of a displayed environment.

FIGS. 5A-7B are diagrams that present example interfaces displayed by the gaming platform.

FIG. 8 is a flow diagram illustrating a method for moving an avatar through a virtual environment.

FIG. 9 is a flow diagram illustrating an example gaming environment that facilitates a multi-modal gaming experience.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Various systems and methods that enhance an exercise activity performed by a user are described. In some embodiments, the systems and methods include a gaming platform that presents video games, virtual games, virtual experiences, and other digital or interactive experiences to players that are working out or performing an exercise activity using an exercise machine.

In some cases, an exercise machine or device, such as a treadmill, exercise bicycle, rower, strength machine, and so on, enables users to perform exercise activities while experiencing a virtual gaming environment. For example, the virtual gaming environment may present user-selectable navigation options to users via diegetic objects (e.g., objects rendered within the virtual environment), maintain certain viewing angles of the virtual environment as the user performs the exercise activity, cause an avatar associated with the user to mimic the user's movements or gestures, and so on.

Thus, the gaming platform described herein may implement various technical improvements (e.g., improvement to a gaming mechanic) that enable a user to navigate to different levels or locations of a gaming environment, and/or perform actions within the gaming environment, while being immersed in their exercise activity and/or associated game play.

Various embodiments of the systems and methods will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Suitable Gaming Platform

The technology described herein is directed, in some embodiments, to providing a user with an enhanced user experience when performing an exercise activity, such as an exercise activity, as part of a connected fitness system or other exercise system. As described herein, the exercise activity can be part of a gaming platform, such as a platform that provides a virtual game, video game, interactive game, or other interactive experience that presents gaming content and actions based on and in response to the exercise activity being performed by the user.

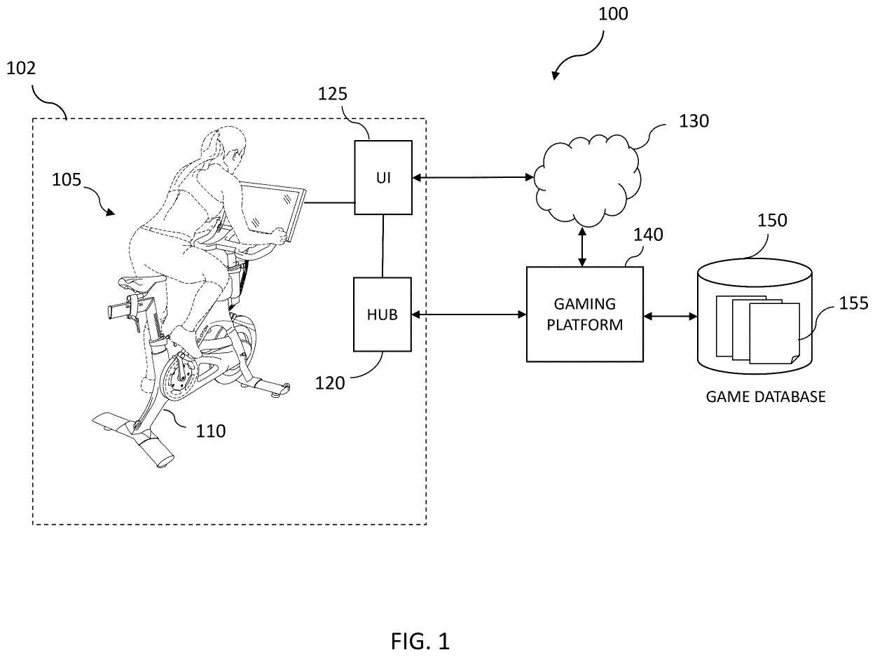

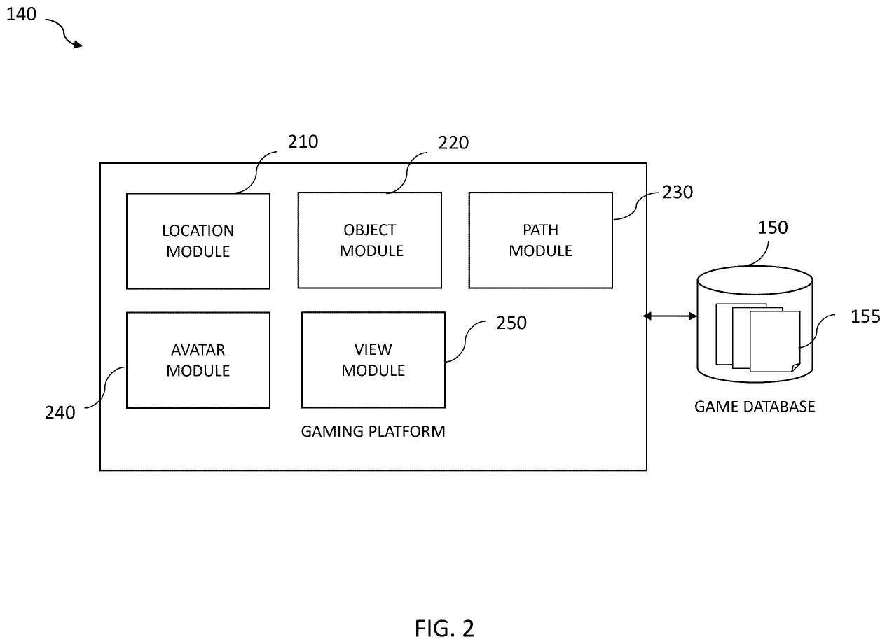

FIG. 1 is a block diagram illustrating a suitable network environment 100 for users or players of a gaming platform 140. In some embodiments, the gaming platform 140 provides various digital games and other digital or virtual experiences to users or members of a connected fitness system or service.

The network environment 100 includes an activity environment 102, where a user 105 is performing an exercise activity, such as a cycling activity. In some cases, the user 105 can perform the activity with an exercise machine 110, such as cycling with an exercise bicycle. The exercise activity performed by the user 105 can include a variety of different workouts, activities, actions, and/or movements, such as movements associated with stretching, doing yoga, lifting weights, rowing, running, walking, cycling, jumping, sports movements (e.g., throwing a ball, pitching a ball, hitting, swinging a racket, swinging a golf club, kicking a ball, hitting a puck), and so on.

The exercise machine 110 can assist or facilitate the user 105 to perform the movements and/or can present interactive content, such as a digital game or gaming environment, to the user 105, such as when the user 105 performs the activity. For example, the exercise machine 110 can be a stationary bicycle or exercise bicycle, a stationary rower, a treadmill, a weight or strength machine, or other exercise machines. As another example, the exercise machine 110 can include a display device that presents content (e.g., classes, dynamically changing video, audio, video games, instructional content, and so on) to the user 105 during an activity or workout. In some cases, the exercise machine includes an auto-adjustment controller, which adjusts or modifies difficulty settings (e.g., resistance or incline) for the exercise machine.

In some embodiments, the user 105 may perform movements using multiple exercise machines when interacting within a digital game or gaming environment. For example, the user 105 may use an exercise bicycle to traverse within an initial section of a gaming environment (e.g., cycling within a virtual biking trail) and then use a strength machine (or weights tracked by the gaming platform 140) to traverse within a subsequent section of the gaming environment (e.g., climbing up virtual boulders along the virtual biking trail). Thus, the gaming platform 140 may support multi-modal gaming experiences using different exercise or equipment modalities accessible to the user 105 within the activity environment 102 (e.g., at home, at a gym or workout facility, and so on).

The exercise machine 110, in some cases, includes or is associated with a media hub 120 and a user interface 125. The media hub 120, in some cases, captures images and/or video of the user 105, such as images of the user 105 performing different movements, or poses, during an activity. The media hub 120 can include a camera or cameras, a camera sensor or sensors, or other optical sensors configured to capture the images or video of the user 105.

In some cases, the media hub 120 includes components configured to present or display information to the user 105. For example, the media hub 120 can be part of a set-top box or other similar device that outputs signals to a display, such as the user interface 125. As another example, the media hub 120, or various components, may be part of the exercise machine 110, such as via a display or tablet of the exercise machine 110. Thus, the media hub 120 can operate to both capture images of the user 105 during an activity (e.g., using a computer vision (CV) system and various sensors or cameras), while also presenting content (e.g., gaming content) to the user 105 during the activity.

The user interface 125 provides the user 105 with an interactive experience, such as a digital video game or interactive game, during the activity. For example, the user interface 125 can present a gaming environment that renders or modifies digital content in response to user actions with the exercise machine 110, such as when the user changes speeds, changes effort levels, changes output levels, changes resistance levels (e.g., for an exercise bicycle or rower), changes incline levels (e.g., for a treadmill), modifies their exercise actions or exercise activity (e.g., stands up or down, hops, leans, or jumps on an exercise bicycle), and so on.

The exercise machine 110, the media hub 120, and/or the user interface 125 can send or receive information over a network 130, such as a wireless network. Thus, in some cases, the user interface 125 is a display device (e.g., attached to the exercise machine 110), that receives content from (and sends information, such as user selections) a gaming platform 140 over the network 130. In other cases, the media hub 120 controls the communication of content to/from the gaming platform 140 over the network 130 and presents the gaming content to the user via the user interface 125.

The gaming platform 140, located at one or more servers remote from the user 105 (e.g., cloud-based servers), can access content via a gaming content database 150, which stores gaming content 155 (images, graphics, music, and so on) to be presented during and/or within a video game.

The gaming platform 140 can present a variety of different video games or digital experiences to the user 105 when the user is performing an exercise activity. For example, the platform 140 can present competition games, abstract games, strategy games, progression games, music rhythm games, and so on. Further details regarding the types of video games or other digital experiences supported by the gaming platform 140 are described herein.

FIG. 1 and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network or cloud 130 can be any network, such as a wired or wireless local area network (LAN), a wired or wireless wide area network (WAN), the Internet or some other public or private network, a cellular or telecommunications (e.g., 4G, LTE, 5G, 6G) network, and so on. While the connections between the various devices and the network 130 and are shown as separate connections, these connections can be any kind of local, wide area, wired, or wireless network, public or private.

Further, any or all components depicted in the Figures described herein can be supported and/or implemented via one or more computing systems, servers, or cloud-based systems. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion.

### Examples of a Diegetic User Experience Within a Virtual Gaming Environment

As described herein, in some embodiments, the systems and methods present video games or other interactive experiences to users within a connected fitness platform, such as users performing exercise activities on treadmills, exercise bicycles, rowing machines, and/or other exercise machines that facilitate the performance of real-world exercise activities (e.g., running, cycling, rowing, and so on). The video games or interactive experiences can include various types of video games, including single-player games, progression games, music games or music-rhythm games, and so on.

FIG. 2 illustrates the various components or modules of the gaming platform 140. The gaming platform 140, or gaming engine, may be a system of components, modules, or devices, and functions to present gaming content to users (e.g., players) of exercise machines, such as members of a connected fitness platform or service.

The components and/or modules of the gaming platform 140 (or gaming engine) can be implemented with a combination of software (e.g., executable instructions, or computer code) and hardware (e.g., at least a memory and processor). Accordingly, as used herein, in some embodiments, a component/module is a processor-implemented component/module and represents a computing device having a processor that is at least temporarily configured and/or programmed by executable instructions stored in memory to perform one or more of the functions that are described herein. For example, the gaming platform 140 includes a location module 210, an object module 220, a path module 230, an avatar module 240, and a view module 250.

In some embodiments, the location module 210 is configured and/or programmed to determine an avatar that represents a user of an exercise machine is moving within a certain section of a virtual environment presented to the user via a display of the exercise machine (e.g., within a game or other virtual experience). For example, the location module 210 may determine the avatar has moved into an area within a displayed environment that is proximate, within the displayed environment, to one or more diegetic objects of the virtual environment.

As described herein, a diegetic object is an object rendered and presented within the rendered gaming environment. For example, a diegetic object may be an object naturally or commonly found within a rendered environment, such as a tree or sign rendered next to a displayed route of travel (e.g., a road or path traveled by the avatar within the virtual or gaming environment). In some cases, background images within the virtual environment may include or be diegetic objects, and/or would be encountered or seen by an avatar within the virtual environment.

In contrast, a non-diegetic object may be an object that is added to the display seen by the user but is not part of or commonly found within the rendered environment (e.g., a display element that is overlaid onto the presented environment, such as a menu of options). Thus, a non-diegetic object would not be seen or encountered by an avatar within the virtual environment. Example diegetic objects are described herein.

In some embodiments, the object module 220 is configured and/or programmed to present an object (e.g., a diegetic object) of the virtual environment to the user of the exercise machine via a display of the exercise machine. For example, the object module 220 may determine the avatar is within a certain distance to the object within the certain section of the virtual environment and modify the object to present one or more user selectable options based on the avatar being within the certain distance to the object.

The object, in some cases, is a diegetic object (e.g., a sign along a path within a cycling virtual environment), and the object module 220, when the avatar moves close to the diegetic object, adjusts the rendering of the diegetic object to present multiple selectable paths of travel (e.g., also displayed as different routes within the virtual environment).

In some embodiments, the path module 230 is configured and/or programmed to, in response to receiving a selection of the object presented within the virtual environment via the display of the exercise machine (e.g., by the user), adjust a path of the avatar through the virtual environment. For example, the path module 230 determines the user has selected one of the selectable paths of travel presented by the diegetic object (e.g., by physically providing input via their display), and performs a game action to cause the avatar to move along a path of travel within the virtual environment based on the selection.

In some cases, the path module 230 may perform the game action when the user associated with the avatar is performing an exercise activity at a certain effort or difficulty level. For example, the object may display a certain range of values (e.g., output values, resistance values, speed values, incline values, and so on), and modify the path of travel within the virtual environment based on a user selection and/or a current performance value for the user.

In some embodiments, the avatar module 240 is configured and/or programmed to render an avatar that represents a user of an exercise machine within a certain section of a virtual environment presented to the user via a display of the exercise machine, track a physical movement of the user of the exercise machine during performance of an exercise activity of the user using the exercise machine, and adjust the avatar based on the physical movement of the user of the exercise machine.

For example, the avatar module 240 may determine, using a CV system or other sensors, that the user has performed a physical gesture during performance of the exercise activity (e.g., pointing with an arm or leaning to one side) and adjust the avatar to perform the gesture (e.g., to mimic the user) within the virtual environment.

In some cases, the object module 220 and/or the path module 240 may be responsive to actions performed, determined, and/or identified by the avatar module 240. For example, the object module 220 may, in response to a physical gesture performed by the user (e.g., the user points towards the right, which is mimicked by their avatar), modify an object to present one or more user selectable options associated with the avatar moving within the certain section of the virtual environment. The path module 230 may also determine the user has selected one option of the one or more user selectable options based on performance of an additional or different gesture (e.g., a lean to the right) and adjust a path of the avatar through the virtual environment associated with the selected one option.

In some embodiments, the view module 250 is configured and/or programmed to modify a rendered gaming environment based on physical movement of the user performing the exercise activity. For example, the view module 250 may determine, using the CV system or other sensors, that the user has moved in a vertical direction during performance of the exercise activity (e.g., has stood up or sat down on an exercise bicycle and/or has moved their head in a different direction) and adjust a viewing angle of the virtual environment displayed to the user based on the movement of the user in the vertical direction. The view module 250 may adjust the viewing angle to maintain a seamless point of view of the displayed environment to the user as they physically move on their exercise machine during an activity.

Thus, in some embodiments, the gaming platform 140 may include the various modules described herein to provide a user with an immersive gaming experience, where the user can control movement within a virtual environment via selections performed within the virtual environment (e.g., via diegetic objects) and/or control actions of an associated avatar within the virtual environment. For example, an exercise bicycle, having a frame, flywheel, and a display, may utilize or support a CV component that captures images or video of a user performing an exercise activity on the exercise bicycle and a gaming engine or gaming platform (e.g., the gaming platform 140) that modifies a rendered gaming environment based on the images or video of the user performing the exercise activity.

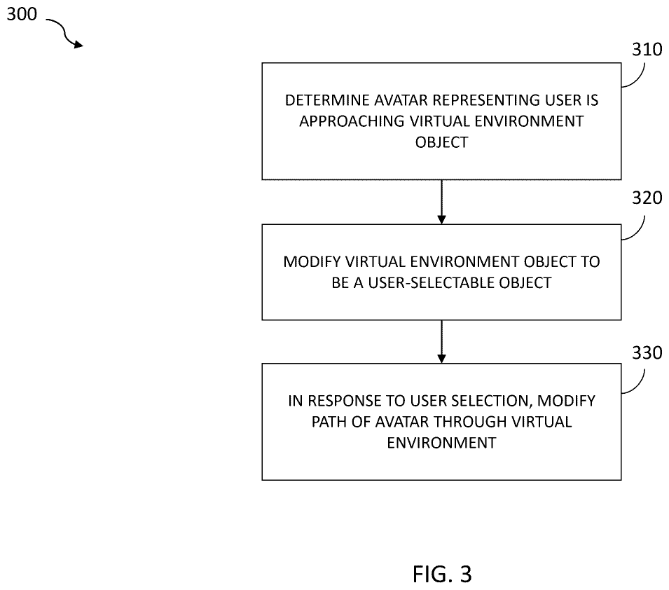

As described herein, the gaming platform 140 may perform processes or methods to facilitate the navigation of a user (e.g., via an associated avatar) through a virtual environment, such as a video game or gaming environment. FIG. 3 is a flow diagram illustrating a method 300 for performing a game action within a virtual environment. The method 300 may be performed by the gaming platform 140 and, accordingly, is described herein merely by way of reference thereto. It will be appreciated that the method 300 may be performed on any suitable hardware.

In operation 310, the gaming platform 140 determines an avatar that represents a user of an exercise machine is approaching a virtual environment object. For example, the object module 220 determines the avatar is moving or has moved within a certain distance to a diegetic object within the virtual environment.

In operation 320, the gaming platform 140 modifies the virtual environment object to be a user-selectable object. For example, the object module 220 causes the diegetic object to present one or more user selectable options based on the avatar being within the certain distance to the object.

In operation 330, the gaming platform 140, in response to receiving a selection of the object presented within the virtual environment via a display of the exercise machine, adjusting a path of the avatar through the virtual environment. For example, the path module 230 may perform a game action to cause the avatar to move along a different path of travel and/or move to a different stage, location, level, or other section of the virtual environment.

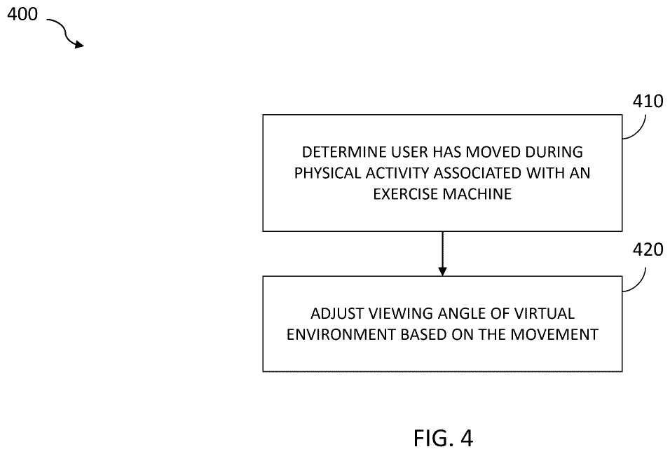

As described herein, the gaming platform 140 may perform processes or methods to maintain the view or viewpoint of the displayed environment as a user performs an exercise activity. FIG. 4 is a flow diagram illustrating a method 400 for adjusting a view of a displayed environment. The method 400 may be performed by the gaming platform 140 and, accordingly, is described herein merely by way of reference thereto. It will be appreciated that the method 400 may be performed on any suitable hardware.

In operation 410, the gaming platform 140 determines a user has moved when performing a physical activity associated with an exercise machine. For example, the view module 250 may determine, using information accessed from a CV system, that the user has moved in a vertical direction during performance of the exercise activity (e.g., is standing on pedals of an exercise bicycle or their head is leaning to one direction).

In operation 420, the gaming platform 140 adjusts a viewing angle of the virtual environment displayed to the user based on the movement of the user. For example, the view module 250 may adjust a viewing angle into the virtual environment, providing a parallax-like effect, rendering the environment to follow the movement of the user (e.g., the eye position of the user) during the exercise activity.

As described herein, the gaming platform 140 may present various user interfaces (UIs) during performance of an exercise activity by a user of an exercise machine. While the following UIs are examples, others may be presented or displayed by the gaming platform 140 when the user is performing an exercise activity associated with an avatar moving through a gaming environment or other video game.

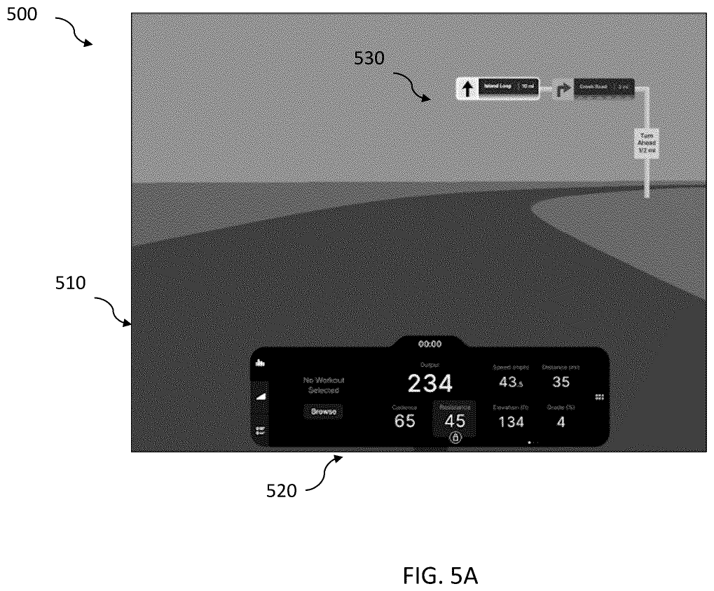

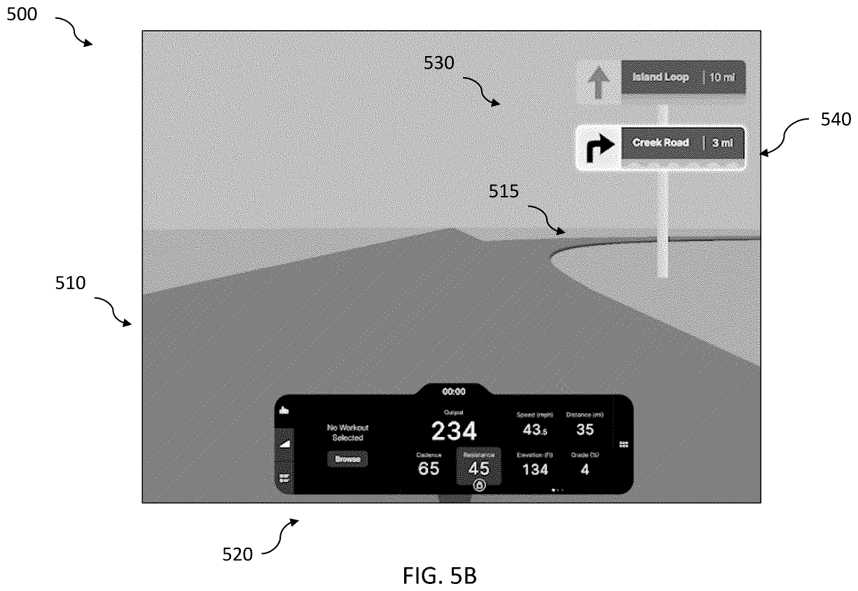

FIGS. 5A-5B depict a gaming environment 500 that presents a route 510 traveled by an avatar associated with performance of an exercise activity by a user of an exercise machine (e.g., an exercise bicycle). For example, the user, viewing a virtual display 520 of their metrics and other information, is traveling along the route 510 within the gaming environment 500. In FIG. 5A, the user (via an avatar, not shown in first person view) is far away from a virtual object 530, which is a road sign (e.g., a diegetic object) displayed along the route 510 of travel.

As the user approaches the virtual object 530, the user (via the unseen avatar) moves within a certain distance to the virtual object 530 within the gaming environment 500. As depicted in FIG. 5B, the virtual object is rendered to display user-selectable options 540, such as two different paths of travel (e.g., “Island Loop” and “Creek Road’). As described herein, the user, via the display of their exercise bicycle, may physically select the “Creek Road” option, which causes the user (via the avatar) to travel to a new route 515 within the gaming environment 500.

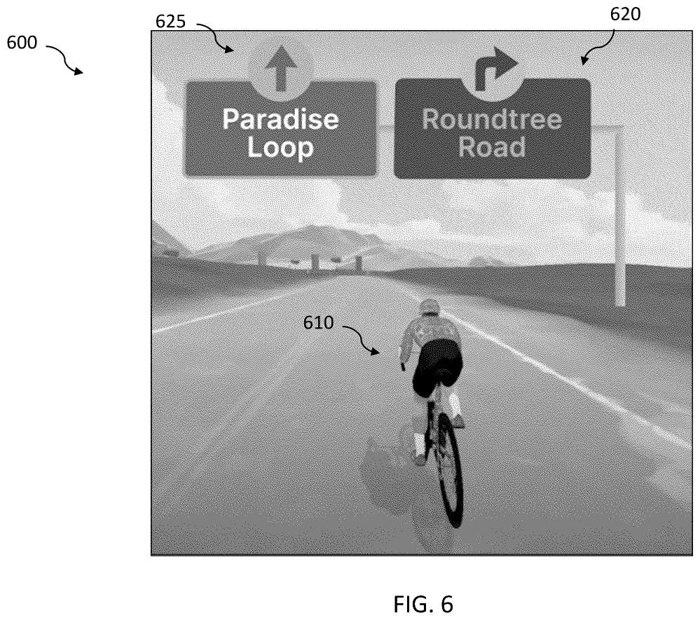

FIG. 6 depicts another example of a diegetic object 600 that presents different user selectable options 620, 625, to an avatar 610 that represents a user performing an exercise activity via an exercise machine. As shown, the user may select the option 620 (e.g., the “Paradise Loop”), which causes a gaming environment to cause the avatar 610 to move to a game location associated with the selected option 620.

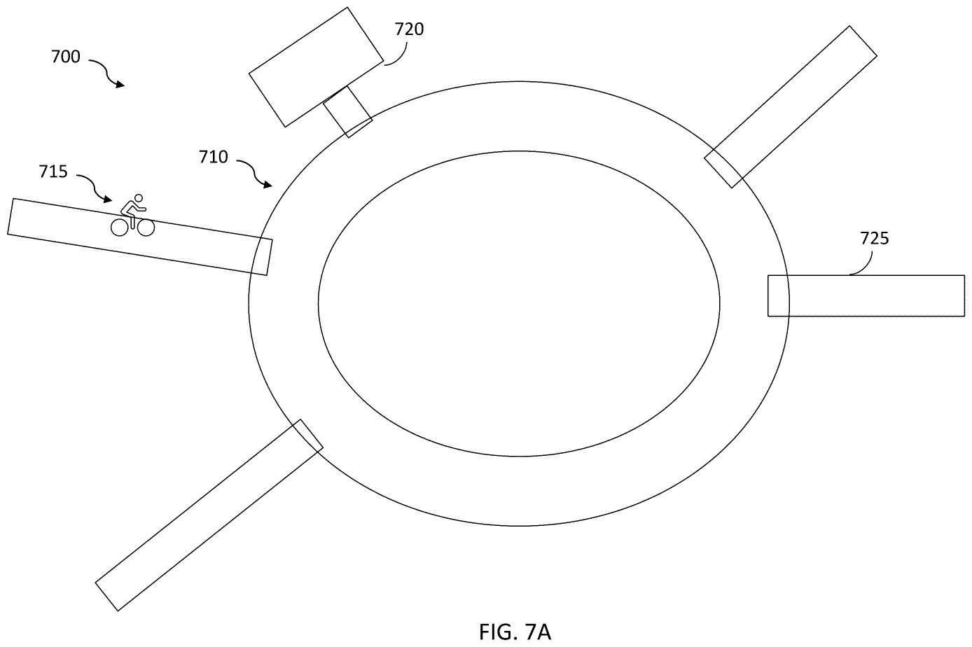

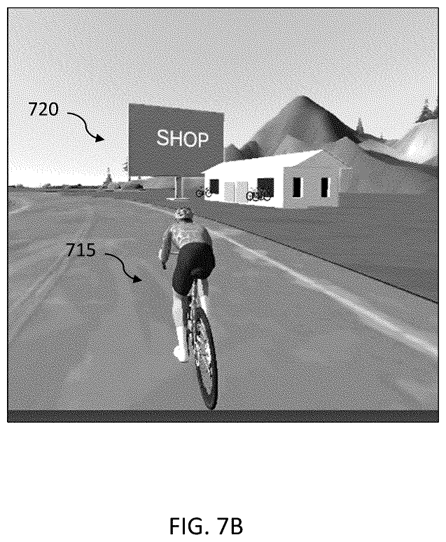

FIGS. 7A-7B depict a hub 700 or display of different virtual locations within a gaming environment. For example, the hub 700 may present different user-selectable options via diegetic objects (e.g., signs, road objects, and so on), such as an option to select a virtual bike shop 710. Upon selection, as described herein, the gaming platform 140 may cause an avatar 715 to progress to a virtual shop 720, where a user can purchase (using virtual or real currency) gear for their avatar, bicycle, and so on. The avatar 715 may continue to progress around the hub until one or more virtual objects or paths 725 are selected by an associated user, in which case the avatar 715 progresses to the selected object or the selected path 725 (or spoke of the hub 710).

For example, the avatar 715 may be shown to ride into a garage or shop, causing an interface to appear that enables the user to purchase gear, tools, or other objects. The avatar 715 may then exit the garage, causing the interface to close, riding out of the garage with the newly equipped items (e.g., a new helmet, enhanced tires, and so on) and transition smoothly back into a previous gameplay state. Thus, the hub 710 may enable a user to navigate to different levels or locations of a gaming environment while being immersed in their exercise activity and/or associated game play.

Other UIs presented by the gaming platform 140 may include:

A virtual cycling computer/display (e.g., associated with virtual handlebars in first person POV), which can display workout stats, workout guidance, and menu options (e.g., via touch screen interaction), via a diegetic UI.

Diegetic objects common to or part of the virtual environment (e.g., road signs, other vehicles, path objects, buildings and building signs, roadside flags), which can present user-selectable game options (as described herein), activity metrics (e.g., output, heart rate, workout zones, and so on);

Festival and event specific presentations (e.g., an “athletic festival of events” within a natural landscape);

A hub or roundabout (as described herein), such as a hub that presents the following example options: ride a ring road via east and west exits, ride a Speed Loop via an exit (e.g., with time trial leaderboard), access a shop (e.g., for character customization), access a different mode of travel or activity (e.g., a helicopter or airport), and so on.

As described herein, in some embodiments, the gaming platform 140 supports multi-modal gaming experiences using different exercise or equipment modalities accessible to the user 105 when playing a game or experiencing a virtual environment. For example, the gaming platform 140 may cause the user 105 to ride an exercise bicycle to traverse within an initial section of a gaming environment (e.g., cycling within a virtual biking trail) and then use a strength machine (or weights tracked by the gaming platform 140) to traverse within a subsequent section of the gaming environment (e.g., climbing up virtual boulders along the virtual biking trail).

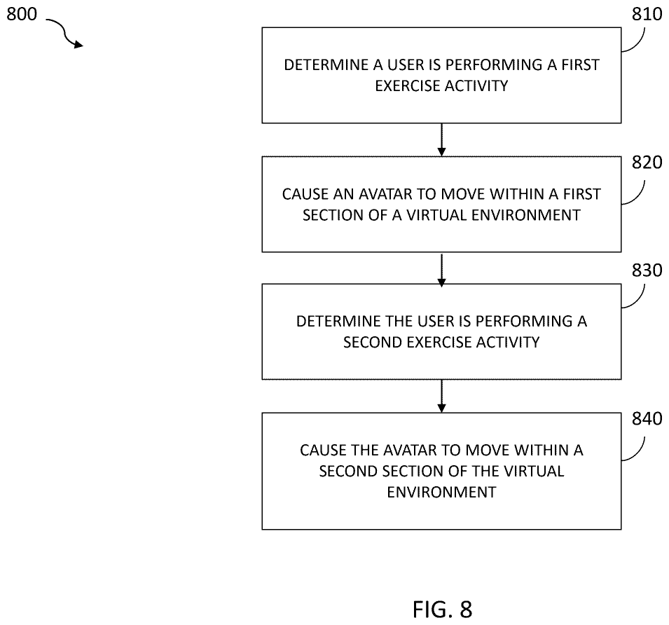

FIG. 8 is a flow diagram illustrating a method 800 for moving an avatar through a virtual environment. The method 800 may be performed by the gaming platform 140 and, accordingly, is described herein merely by way of reference thereto. It will be appreciated that the method 800 may be performed on any suitable hardware.

In operation 810, the gaming platform 140 determines a user is performing a first exercise activity. For example, the gaming platform 140 may determine the user 105 is running on a treadmill.

In operation 820, the gaming platform 140 causes an avatar associated with the user to move within a first section of a virtual environment. For example, the gaming platform 140 causes an avatar representing the user 105 to run along a path within the virtual environment at a speed that is associated with the user 105 running on the treadmill.

In operation 830, the gaming platform 140 determines the user is performing a second exercise activity. For example, the gaming platform 140 may determine the user 105 is performing a strength movement (e.g., a shoulder press) via a strength machine.

In operation 840, the gaming platform 140 causes the avatar associated with the user to move within a second section of the virtual environment. For example, the gaming platform 140 causes the avatar representing the user 105 to lift an object within the virtual environment to a level is that associated with the strength movement performed by the user 105.

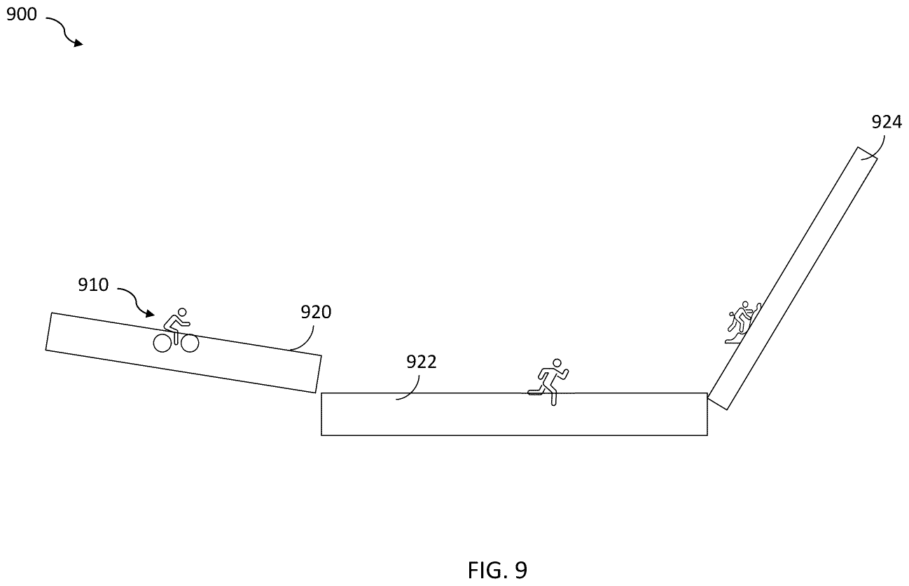

FIG. 9 depicts a gaming environment 900 that facilitates a multi-modal gaming experience. As shown, the gaming environment 900 may cause an avatar 910 associated with a user to navigate through the gaming environment 900 based on the performance of different or disparate exercise activities.

For example, the gaming platform 140 may enable the avatar 910, displayed as a cyclist, to traverse a first location 920 (e.g., a bike path through the woods) in response to the user riding an exercise bicycle. Then, the avatar 910 may encounter a second location 922 (e.g., a jetty at a beach). The gaming platform 140, may enable the avatar 910, now displayed as a runner, to traverse the second location 922 in response to the user running on a treadmill. Finally, the avatar 910 may encounter a third location 924 (e.g., a trail up a mountain). The gaming platform enables the avatar 910, in displayed in climbing gear, to traverse the third location 924 in response to the user doing pull-ups or lat pull-downs on a strength machine.

Thus, in some examples, the gaming platform 140 may facilitate the user 105, via an associated avatar, to navigate, traverse, move, or progress through different levels or locations of a virtual environment based on performing different or disparate exercise activities.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A method, comprising:
determining an avatar that represents a user of an exercise machine is moving within a certain section of a virtual environment presented to the user via a display of the exercise machine;
presenting an object of the virtual environment to the user of the exercise machine via a display of the exercise machine; and
upon receiving a selection of the object presented within the virtual environment via the display of the exercise machine, adjusting a path of the avatar through the virtual environment.

2. The method of claim 1, wherein presenting an object of the virtual environment to the user of the exercise machine includes:
determining the avatar is within a certain distance to the object within the virtual environment; and
modifying the object to present one or more user selectable options based on the avatar being within the certain distance to the object.

3. The method of claim 1, wherein the exercise machine is an exercise bicycle, the method further comprising:
accessing an output value associated with the user pedaling the exercise bicycle; and
causing the avatar to move within the certain section of the virtual environment based on the accessed output value.

4. The method of claim 1, wherein the exercise machine is a treadmill, the method further comprising:
accessing an output value associated with the user running on the treadmill; and
causing the avatar to move within the certain section of the virtual environment based on the accessed output value.

5. A method, comprising:
rendering an avatar that represents a user of an exercise machine within a certain section of a virtual environment presented to the user via a display of the exercise machine;
tracking a physical movement of the user of the exercise machine during performance of an exercise activity of the user using the exercise machine; and
adjusting the avatar based on the physical movement of the user of the exercise machine.

6. The method of claim 5, wherein tracking the physical movement of the user comprises:
determining, using a computer vision (CV) system, that the user has performed a physical gesture during performance of the exercise activity; and
adjusting the avatar to perform the gesture within the virtual environment.

7. The method of claim 6, further comprising:
presenting an object within the virtual environment to the user; and
in response to the physical gesture performed by the user, modifying the object to present one or more user selectable options associated with the avatar moving within the certain section of the virtual environment.

8. The method of claim 7, further comprising:
determining the user has selected one option of the one or more user selectable options based on performance of an additional gesture; and
adjusting a path of the avatar through the virtual environment associated with the selected one option.

9. The method of claim 5, wherein tracking the physical movement of the user comprises:
determining, using a computer vision (CV) system, that the user has moved in a vertical direction during performance of the exercise activity; and
adjusting a viewing angle of the virtual environment displayed to the user based on the movement of the user in the vertical direction.

10. The method of claim 5, wherein tracking the physical movement of the user comprises:
determining, using a computer vision (CV) system, that a head of the user has moved during performance of the exercise activity; and
adjusting a viewing angle of the virtual environment displayed to the user based on the movement of the head of the user.

11. An exercise bicycle, comprising:
a frame;
a display supported by the frame; and
a gaming platform associated with the display and including:
a computer vision (CV) component that captures images of a user performing an exercise activity on the exercise bicycle; and
a gaming engine that modifies a rendered gaming environment based on the images of the user performing the exercise activity.

12. The exercise bicycle of claim 11, wherein the CV component captures images of the user leaning in a certain direction; and
wherein the gaming engine causes an avatar representing the user within the rendered gaming environment to select a path of travel within the rendered gaming environment based on the certain direction.

13. The exercise bicycle of claim 11, wherein the selected path of travel is associated with a displayed hub of multiple paths of travel presented within the rendered gaming environment.

14. The exercise bicycle of claim 11, wherein the CV component captures images of the user performing a gesture; and
wherein the gaming engine causes an avatar representing the user within the rendered gaming environment to perform the gesture within the rendered gaming environment.

15. The exercise bicycle of claim 11, wherein the CV component captures images of the user standing up on the exercise bicycle; and
wherein the gaming engine adjusts a viewing angle into the rendered gaming environment based on the user standing up on the exercise bicycle.

16. The exercise bicycle of claim 11, wherein the gaming engine includes:
an object module that presents a diegetic object with the rendered gaming environment having one or more user selectable options associated with navigation of an avatar representing the user within the rendered gaming environment; and
a path module that causes the avatar representing the user to move within the rendered gaming environment to one or more paths associated with the one or more user selectable options.

17. The exercise bicycle of claim 16, wherein the object module receives a selection by the user of the one or more user selectable options via the display of the exercise bicycle.

18. The exercise bicycle of claim 16, wherein the diegetic object is an object presented within the rendered gaming environment.

19. The exercise bicycle of claim 16, wherein the object module:
determines the avatar is within a certain distance to the diegetic object within the rendered gaming environment; and
modifies the diegetic object to present the one or more user selectable options based on the avatar being within the certain distance to the diegetic object.

20. The exercise bicycle of claim 11, wherein the gaming engine includes:
an object module that presents a diegetic object with the rendered gaming environment that displays metrics associated with the user performing the exercise activity on the exercise bicycle.
